(19) United States
(12) Patent Application Publication
(10) Pub. No.: US 2021/0208003 A1
(43) Pub. Date: Jul. 8, 2021

(54) THERMAL ASSEMBLY EMITTER

(71) Applicant: HEWLETT-PACKARD DEVELOPMENT COMPANY, L.P., Spring, TX (US)

(72) Inventors: Joshua Peter YASBEK, Vancouver, WA (US); Todd GOYEN, Vancouver, WA (US); David SORIANO, Vancouver, WA (US); Asa WEISS, Vancouver, WA (US); Arthur H. BARNES, Vancouver, WA (US)

(73) Assignee: HEWLETT-PACKARD DEVELOPMENT COMPANY, L.P., Spring, TX (US)

(21) Appl. No.: 16/075,701

(22) PCT Filed: Jul. 12, 2017
(86) PCT No.: PCT/US2017/041744

§ 371 Date: Aug. 6, 2018

(51) Int. Cl. G01J 5/04; G01J 5/08; G01J 5/02; B29C 64/30

(52) U.S. Cl. CPC G01J 5/04; G01J 5/0896; G01J 2005/0077; B29C 64/30; G01J 5/0205

(57) ABSTRACT

Some examples include a thermal imaging assembly, comprising a thermal sensor having a field of view and optics, an emitting source to validate the optics in the field of view, an emitter storage to selectively house the emitting source outside of the field of view, and a carrier to move the emitting source between the emitter storage and the field of view.

### BACKGROUND

Non-contact thermal measurement devices such as thermal cameras are used to provide feedback in systems that generate heat, such as three-dimensional printers and other systems. For instance, by monitoring the heat generated by an object within a system, extreme heating conditions that might otherwise damage the object and/or system can be detected before the damage becomes irreparable.

### BRIEF DESCRIPTION OF THE DRAWINGS

FIG. 1 is a schematic view of a thermal imaging assembly according to an example of the present disclosure.

FIG. 2A is a perspective view of a thermal imaging assembly in a validating state according to an example of the present disclosure.

FIG. 2B is a perspective view of the thermal imaging assembly in a protected state according to an example of the present disclosure

FIG. 3 is a perspective view of an example drive mechanism useful in a thermal camera assembly in accordance with the present disclosure.

FIG. 4 is a schematic view of an additive manufacturing machine including a thermal imaging assembly according to an example of the present disclosure.

FIG. 5 is a flow chart of an example method in accordance with aspects of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Various types of imaging devices, such as optical cameras or thermal imaging devices, may be used in any of a variety of environments. Optical cameras or other types of non-contact thermal imaging devices can be employed in various manufacturing environments, including highly thermally dynamic environments such as additive manufacturing machines. In various examples, thermal imaging devices can be used to identify proper fusion or solidification of a material used in manufacturing of additive manufactured (i.e., 3D-printed) objects. In one example, a thermal imaging device may be used to detect that the material is reaching a proper or desired temperature for proper fusion.

Thermal imaging devices can be employed to detect that a material in an additive manufacturing machine is reaching a desired temperature for proper fusion, for example. In such environments, an additive manufacturing machine may cause particulates (e.g., powder) or other contaminants may become airborne and accumulate on a lens, sensor, or other component of the imaging device, resulting in interference in the capturing of the image. Accuracy of measurements detected by thermal imaging device can be influenced, or effected, by contaminants on the sensor itself or in the field of view of the sensor. Consistency of mathematical models, or techniques, that relate a signal generated by the sensor to the temperature of the observed region by the sensor can decrease as contamination of the sensor's field of view is incorporated. This effect can be greater for a time variant temperature profile of a thermal sensor. It is desirable to maintain a thermal imaging device (e.g., thermal camera) contaminant-free to improve the measurement accuracy of the thermal sensor. For example, in the case of a thermal camera, with sufficient accumulation of contaminants, the thermal camera may detect the temperature of the accumulated contaminants rather than the targeted material being fused.

When employed in an additive manufacturing machine, the ambient temperature can be higher than a tolerable level for the sensor to function properly. An enclosure can be included to aid in protecting the thermal imaging device (e.g., on the lens of the thermal imaging device) from accumulation of contaminants, such as powders, and thermal influences within the additive manufacturing environment. The enclosure includes an aperture through which the field of view of the imaging device passes.

As discussed above, non-contact thermal measurement devices such as thermal cameras (i.e., cameras that form images using infrared radiation) are used to provide feedback in systems that generate heat. The accuracy of a non-contact thermal sensor depends on how accurately incident radiation on the sensor (e.g., lens) of the non-contact thermal measurement device can be correlated to an inferred temperature of the monitored object. However, this correlation can be skewed by contamination on the sensor (e.g., dust, powder, or the like on the lens) and/or by thermal aging of the sensor. A radiometrically characterized, diffusely emitting isothermal radiation source can be introduced for verifying the measurement accuracy of a non-contact thermal measurement device. Examples of the present disclosure provide an emitting source of radiation, for example, for verifying the accuracy of a non-contact thermal measurement device (e.g., a thermal camera).

By knowing the temperature of the emitting source, one can infer the heat emission value that the non-contact thermal measurement device is expected to be measuring, and can determine whether the value that the non-contact thermal measurement device is actually measuring is within some variance of what it is expected to be measuring. Knowing the temperature of the emitter face, one can determine the value that the non-contact thermal measurement device is expected to measure for the heat emission of the emitter face (e.g., the expected value may be related to the temperature of the emitter face in a lookup table). If the measurement of the non-contact thermal measurement device is not within some predefined variance (e.g., three degrees Celsius) of that expected measurement, then the non-contact thermal measurement device may be assumed to be malfunctioning or contaminated, and may be removed for cleaning and/or repairs.

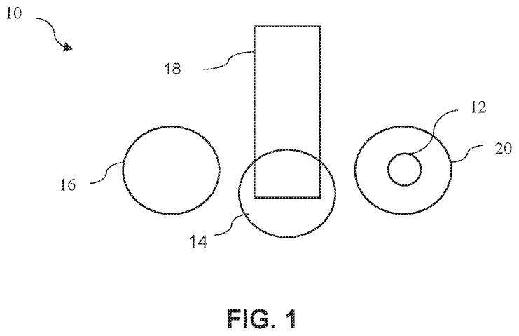

FIG. 1 is a schematic illustration of thermal camera assembly 10 according to an example of the present disclosure. Thermal cameral assembly 10 includes a thermal sensor 12, an emitting source 14, an emitter storage 16, and a carrier 18. Thermal sensor 12 has optics and a field of view 20. Carrier 18 is used to carry and move emitting source 14 between emitter storage 16 and field of view 20 of thermal sensor 12. Emitting source 14 is used to validate, or verify, the measurement accuracy of the optics in field of view 20 of thermal sensor 12.

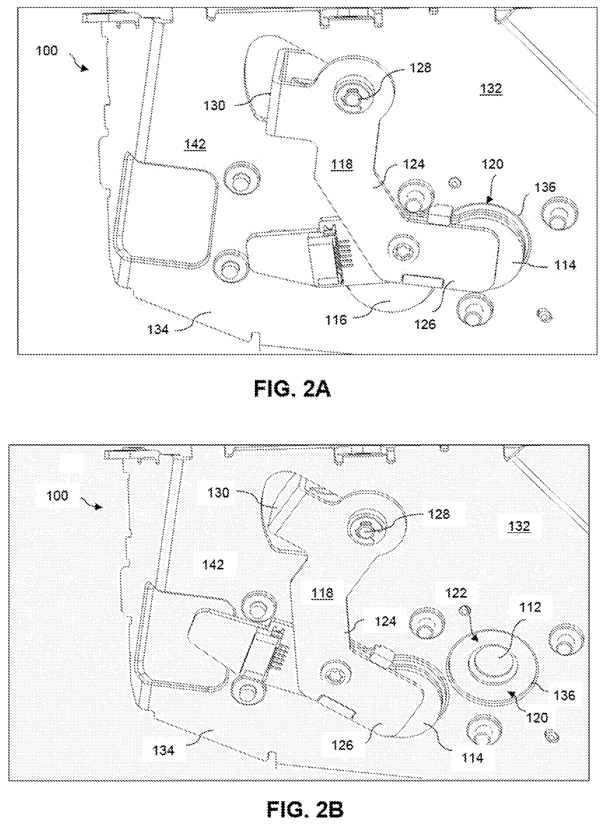

FIGS. 2A and 2B are a perspective views of a thermal camera assembly 100 according to an example of the present disclosure. FIG. 2A illustrates thermal camera assembly 100 in a validating state and FIG. 2B illustrates thermal camera assembly 100 in an emitter protected state, or emitter stored state, as described more fully below.

Thermal sensor assembly 100 includes a thermal sensor 112, an emitting source 114, an emitter storage 116, and a carrier 118. Emitting source 114 can be used to validate, or verify, the measurement accuracy of thermal sensor 112. Thermal sensor 112 can include optics. Validation of the condition of the optics for calibration is desirable. Emitting source 114 is positioned within a field of view of sensor to validate, or verify, the condition of the optics. Emitting source is removed from the field of view 120 upon completion of the validations in order that sensor 112 can perform sensing thermal data of the intended target object. Emitting source 114 is carried on movable carrier 118 to move into and out of field of view 120 of thermal sensor 112.

Thermal sensor 112 can be including in a thermal imaging device 122, only partially illustrated with thermal sensor 112. Thermal imaging device 122 can be any of a variety of thermal imaging devices, such as a thermal camera, for capturing thermal data including temperature. In one example, thermal imaging device 122 is a non-contact thermal imaging device. Thermal imaging device 122 can be an infrared imaging device. In one example, thermal imaging device 122 is a bolometer. Thermal imaging device 122 includes sensor 112 to sense a thermal image of a target object. The thermal image obtained by sensor 112 can include a thermal profile of the target object.

Thermal image assembly 100 can be employed within a heat generating system, such as a three-dimensional printer (also referred to as an “additive manufacturing system”), according to an example illustrated in FIG. 4 of the present disclosure. Contamination accumulated on sensor or a lens disposed over sensor, for example, within the field of view resulting from the additive manufacturing process can interfere with accuracy of thermal imaging device.

FIG. 2A illustrates thermal camera assembly 100 in a validating state, with emitting source 114 positioned over, and obstructing, field of view 120 of thermal sensor 112. Emitting source 114 is a calibrated emission source that is movable to the field of view 120 of thermal sensor 112 in order to validate the conditions (i.e., measurement accuracy) of the optics including contamination adhesion to sensor (including a lens of sensor) and to compensate for output signal changes such as sensor drift and pink noise. Pink noise, or 1/f noise, can be inherent in some thermal imaging devices 122, such as bolometers. Emitting source 114 includes an emitter surface (not shown) that is oriented toward sensor 112 when positioned over sensor 112. It is desirable to maintain emitter surface clean and free of contaminates in order to maintain the emission characteristics of emitting source 114. Emitter storage 116 aids in maintaining emitter surface clean and free of contaminates.

FIG. 2B illustrates thermal camera assembly 100 in an emitter protected state, or emitter stored state, with emitting source 114 positioned at emitter storage 116. Emitting source 114 is selectively positioned within, or over, emitter storage 116 when not validating thermal sensor 112. Emitter storage 116 is sized and shaped to accommodate at least emitter surface of emitting source 114. Emitter storage 116 can include a compliant surface that is effectively impermeable to the migration of contaminants such as build powder.

Emitter storage 116 can be positioned proximate to thermal sensor 112 at field of view 120. Emitter storage 116 selectively houses, or stores, emitting source 114, outside of field of view 120. Proximity between emitter storage 116 and field of view 120 can minimize travel time between emitter storage 116 and field of view 120 for quick response time in positioning emitting source 114 into field of view 120 and emitter storage 116. This can decrease possible contamination of emitter surface during travel. Emitter storage 116 can provide a protective area for emitting source 114 to keep contaminants from being adhered to emitter surface. In one example, emitter surface is wiped, or slidably moved across a surface of emitter storage 116 to remove contaminants. Emitter storage 116 protects the integrity of emitter source's 114 emission properties and characteristics.

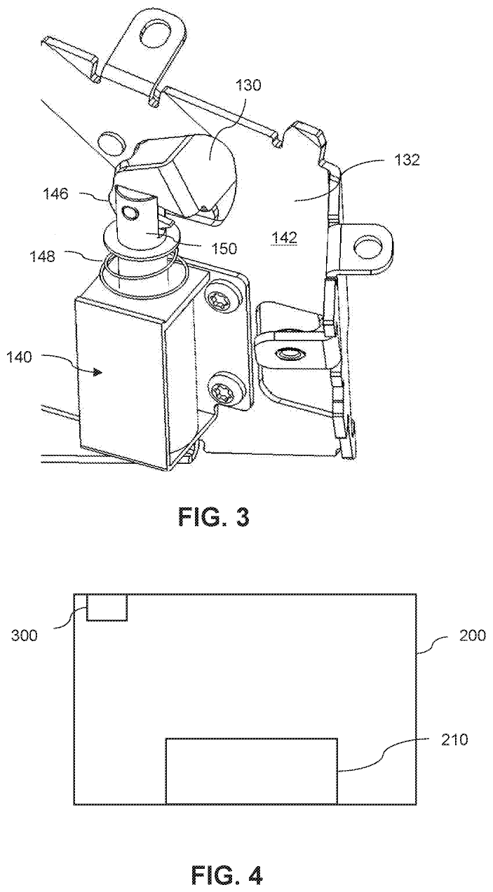

Emitting source 114 is coupled to carrier 118. Carrier 118 can include a first arm 124 coupled to emitting source 114 at a first end 126 of first arm 124. Carrier 118, and in particular, first arm 124 can be pivotably movable about a pivot point 128. Carrier 118 is movable to transition emitting source 114 back and forth between field of view 120 of sensor 112 and emitter storage 116. A second arm 130 of carrier 118 is coupled to a drive mechanism 140 (see, e.g., FIG. 3) used to move carrier 118, and emitting source 114 coupled to first arm 124 of carrier 118, between emitter storage 116 and field of view 120 of sensor 112. Carrier 118 can be formed of a thermally insulative material, such as plastic (e.g., a high glass transition plastic) or stainless steel, for example.

Thermal imaging device 122, only partially illustrated in FIGS. 2A and 2B with sensor 112, is housed within housing 132. Carrier 118 can reposition emitting source 114 movably along an exterior of housing 132. Housing 132 can substantially isolate thermal imaging device 122 from many contaminants. Housing 132 includes a sensor opening 136 sized and positioned to accommodate field of view 120 of sensor 112. Thermal imaging device 122, in particular, sensor 112, can be positioned such that sensor opening 136 is concentric with field of view 120 of sensor 112 and does not interfere with field of view 120 of sensor 112. Emitter storage 116 is disposed on housing 132 and can be adjacent to sensor opening. In some examples, emitter storage can extend within, or partially within, housing 132. In one example, emitter storage 116 is disposed on an exterior surface 134 of housing 132. In one example, emitting source 114 coupled to first arm 124 of carrier 118 is movable between emitter storage 116 and sensor opening 136 along a plane parallel to wall 142 of housing 132 that emitting source 114 transitions along. Carrier 118 can be pivotably attached to housing 132 at pivot point 128. Alternatively, carrier 118 can be slidably or otherwise movably attached to housing 132.

FIG. 3 illustrates an example drive mechanism 140 useful for moving emitting source 114 of thermal imaging assembly 100 in accordance with aspects of the present disclosure. Drive mechanism 140 is coupled to second arm 130 of carrier 118. Second arm 130 can be configured to extend from a plane defined along first arm 124 along wall 142 of housing 132, to extend through wall 142 of housing 132 and terminate on an interior of housing 132. A second end 144 of second arm 130 is coupled to drive mechanism 140. In one example, second end 144 includes a hook 146 to attach to drive mechanism 140. As illustrated in FIG. 3, in one example, drive mechanism 140 can be a solenoid including a biasing mechanism 148 such as a spring and a drive leg 150. In one example, a linear motion of drive leg 150 can be transferred to cause carrier 118 to rotatably move around pivot point 128. In other examples, drive mechanism 140 can be a motor, with or without a gear train, or other appropriate drive mechanism. In a biased or idle state, drive mechanism 140 can position emitting source 114 at emitting storage 116 as illustrated in FIG. 2B. In an unbiased or energized state, drive mechanism 140 positions emitting source 114 within the field of view 120 of sensor 112 as illustrated in FIG. 2A.

FIG. 4 is a schematic view of an additive manufacturing machine 200 including thermal imaging assembly 300. Thermal device assembly 300 can provide for calibration of a sensor during operation of additive manufacturing machine 200, including during a build process. Contamination of the sensor (e.g., sensor lens, or window) can change a source to signal ratio, or a correlation between the observed, or detected, temperature of the target object and real temperature. Such contaminants may include dust particles commonly present in the atmosphere or specific contaminants that may be present in the particular environment of additive manufacturing machine 200. Thermal imaging assembly 300 is similar to thermal imaging assembly 100 with a thermal imaging device housed within housing. An additional enclosure may be included with thermal imaging assembly 300 and positioned over thermal imaging device to further enclose thermal imaging device and additionally protect thermal imaging assembly 300, including emitting source coupled to carrier, from contaminants within a build chamber 210 of additive manufacturing machine 200. Thermal imaging assembly 300 can be employed to monitor the temperature of the layers of build material of a targeted object to ensure proper fusing during a build process of additive manufacturing machine.

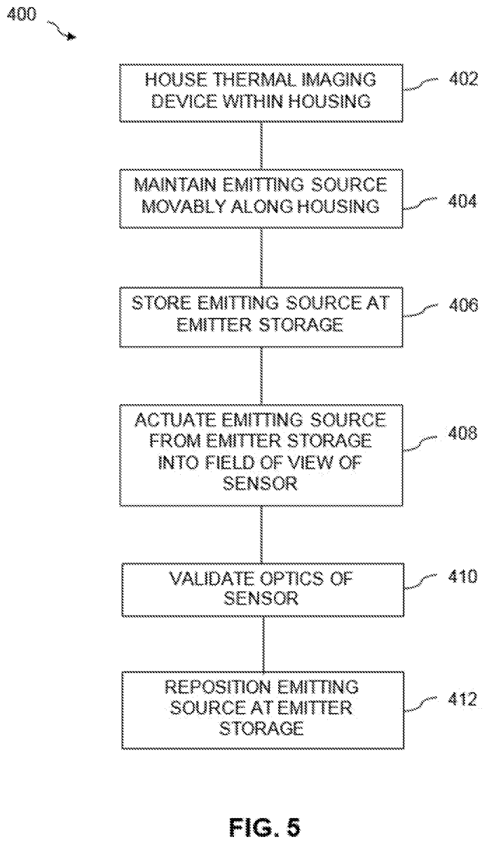

FIG. 5 is a flow chart of an example method 400 in accordance with aspects of the present disclosure. At 402, a thermal imaging device is housed within a housing. At 404, an emitting source movably maintained along the housing. At 406, an emitting source is stored at an emitter storage disposed on the housing. At 408, the emitting source is actuated from the emitter storage into the field of view. At 410, the optics of the sensor are validated. At 412, the emitting source is repositioned at the emitter storage.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A thermal imaging assembly, comprising:
a thermal sensor having a field of view and optics;
an emitting source to validate the optics in the field of view;
an emitter storage to selectively house the emitting source outside of the field of view; and
a carrier to move the emitting source between the emitter storage and the field of view.

2. The thermal imaging assembly of claim 1, wherein the emitting source is carried on an arm of the carrier.

3. The thermal imaging assembly of claim 1, wherein the carrier is pivotally movable.

4. The thermal imaging assembly of claim 1, comprising:
a housing including an opening, wherein the thermal sensor is housed within the housing, wherein the field of view is aligned with the opening, and wherein the emitting source is movable along an exterior of the housing to the opening.

5. The thermal imaging assembly of claim 1, wherein the carrier is thermally insulative.

6. The thermal imaging assembly of claim 1, wherein the thermal sensor is a non-contact thermal sensor.

7. The thermal imaging assembly of claim 4, wherein the carrier is extends from an interior of the housing to the exterior of the housing, wherein the carrier is movable with one of a solenoid, a motor, or a gear train housed within the housing.

8. A thermal imaging assembly in an additive manufacturing machine, comprising:
a thermal imaging device including a sensor having a field of view;
an emitting source to validate the sensor;
a housing to house the thermal imaging device within the additive manufacturing machine, the housing including an opening and an emitter storage, wherein the opening is aligned with the field of view, the emitter storage to selectively house the emitting source; and
a carrier to transition the emitting source between a protected state and a validating state, wherein the emitting source in the protected state is positioned at the emitter storage, and wherein the emitting source in the validating state is positioned at the opening.

9. The thermal imaging assembly of claim 8, wherein the carrier is to translate the emitter along an exterior plane of the housing between the opening and the emitter storage.

10. The thermal imaging assembly of claim 8, wherein the carrier includes a first arm coupled to the emitter source, and a second arm coupled to a drive mechanism.

11. The thermal imaging assembly of claim 10, wherein the carrier is rotatably coupled to the housing at a pivot point.

12. A method comprising:
housing a thermal imaging device within a housing, the thermal imaging device including a sensor having optics and a field of view;
maintaining an emitting source movably along the housing;
storing an emitting source at an emitter storage disposed on the housing;
actuating the emitting source from the emitter storage into the field of view;
validating the optics of the sensor; and
repositioning the emitting source at the emitter storage.

13. The method of claim 12, wherein actuating the emitting source includes translating the emitting source along an exterior plane of the housing between the field of view opening and the emitter storage.

14. The method of claim 12, comprising:
biasing the emitting source toward the emitter storage.

15. The method of claim 12, comprising:
removing contaminants from a validating surface of the emitting source with a surface of the emitter storage.
